(19) United States
(12) Patent Application Publication
(10) Pub. No.: US 2003/0075351 A1
(43) Pub. Date: Apr. 24, 2003

(54) Wall hanging type switch device of ceiling fan

(76) Inventor: Chung-Min Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/983,139

(22) Filed: Oct. 23, 2001

(51) Int. Cl. H02G 3/08

(52) U.S. Cl. 174/52.1

(57) ABSTRACT

A wall hanging type switch device of a ceiling fan includes a receiver, and a control switch having an emitter for controlling the receiver in a wireless manner, and a face plate removably mounted on the emitter. Thus, the face plate may be detached and removed from the body of the emitter easily and rapidly, thereby facilitating replacing the battery, and thereby facilitating the user adjusting the codes of the encoder to correspond to the codes of the encoder of the receiver.

### BACKGROUND OF THE INVENTION

1. Field of the Invention

The present invention relates to a wall hanging type switch device of a ceiling fan, and more particularly to a wall hanging type switch device of a ceiling fan, wherein the face plate may be detached and removed from the body of the emitter easily and rapidly, thereby facilitating replacing the battery, and thereby facilitating the user adjusting the codes of the encoder to correspond to the codes of the encoder of the receiver.

2. Description of the Related Art

A conventional wall hanging type switch device of a ceiling fan in accordance with the prior art shown in FIG. 5 comprises a control switch 80 mounted on a vertical wall (not shown), and a receiver 90 mounted in a ceiling fan (not shown) and controlled by the control switch 80. The control switch 80 is securely mounted in the vertical wall, and is provided with an emitter (not shown) and an encoder 86 therein. The encoder 86 of the control switch 80 has codes in correspondence with that contained in the encoder 96 of the receiver 90. The control switch 80 is connected to the power supply of the ceiling, and is provided with a transformer (not shown) for transforming the alternating current voltage of 110V of the power supply of the ceiling into a direct current voltage of 12V, to serve as the electric power of the emitter in the control switch.

However, the conventional wall hanging type switch device of a ceiling fan has the following disadvantages.

1. The control switch 80 has to be provided with a transformer, so that the control switch 80 has a relatively larger volume, thereby occupying a larger space, and thereby increasing cost of fabrication.

2. The control switch 80 is entirely built in the vertical wall, so that the user has to wholly remove the control switch 80 from the vertical wall for adjusting the codes of the encoder 86 of the control switch 80 to correspond with that contained in the encoder 96 of the receiver 90, thereby easily causing inconvenience of maintenance of the control switch 80, and adjustment of the codes of the encoder 86 of the control switch 80.

### SUMMARY OF THE INVENTION

The present invention has arisen to mitigate and/or obviate the disadvantage of the conventional wall hanging type switch device of a ceiling fan.

The primary objective of the present invention is to provide a wall hanging type switch device of a ceiling fan, wherein the face plate may be detached and removed from the body of the emitter easily and rapidly, thereby facilitating replacing the battery, and thereby facilitating the user adjusting the codes of the encoder to correspond to the codes of the encoder of the receiver.

Another objective of the present invention is to provide a wall hanging type switch device of a ceiling fan, wherein the electric power of the emitter is supplied by a battery, so that the emitter needs not to be additionally provided other parts such as the transformer and the like, so that the emitter may be made with a relatively smaller volume, thereby greatly shortening the volume of the emitter, and thereby greatly shortening the volume of the wall hanging type switch device of the present invention.

In accordance with the present invention, there is provided a wall hanging type switch device of a ceiling fan, comprising:

a receiver; and

a control switch, including an emitter for controlling the receiver in a wireless manner, and a face plate removably mounted on the emitter.

The control switch further includes:

a casing;

a support frame mounted on the casing, and the emitter mounted on the support frame; and

a slotted cover mounted on the support frame to enclose the support frame and the emitter.

The emitter includes a body mounted on the support frame and secured to the casing.

The casing has four corners each formed with a locking hole, and the body of the emitter is provided with four hooks each locked in the locking hole of the casing.

The body of the emitter has four corners each formed with a socket, and the face plate has four corners each provided with a plug inserted into the socket of the body of the emitter for detachably mounting the face plate on the body of the emitter.

The emitter includes a battery mounted in a receiving chamber formed in the body for supplying an electric power to the emitter, so that the emitter may supply a wireless signal to the receiver.

The emitter includes an encoder mounted in a space formed in the body.

The support frame is formed with an opening for receiving the emitter.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wall hanging type switch device of a ceiling fan in accordance with a first embodiment of the present invention;

FIG. 2 is a partially exploded perspective view of the wall hanging type switch device of a ceiling fan as shown in FIG. 1;

FIG. 3 is an exploded perspective view of the wall hanging type switch device of a ceiling fan as shown in FIG. 1;

FIG. 4 is a perspective view of a wall hanging type switch device of a ceiling fan in accordance with a second embodiment of the present invention; and

FIG. 5 is a perspective view of a conventional wall hanging type switch device of a ceiling fan in accordance with the prior art.

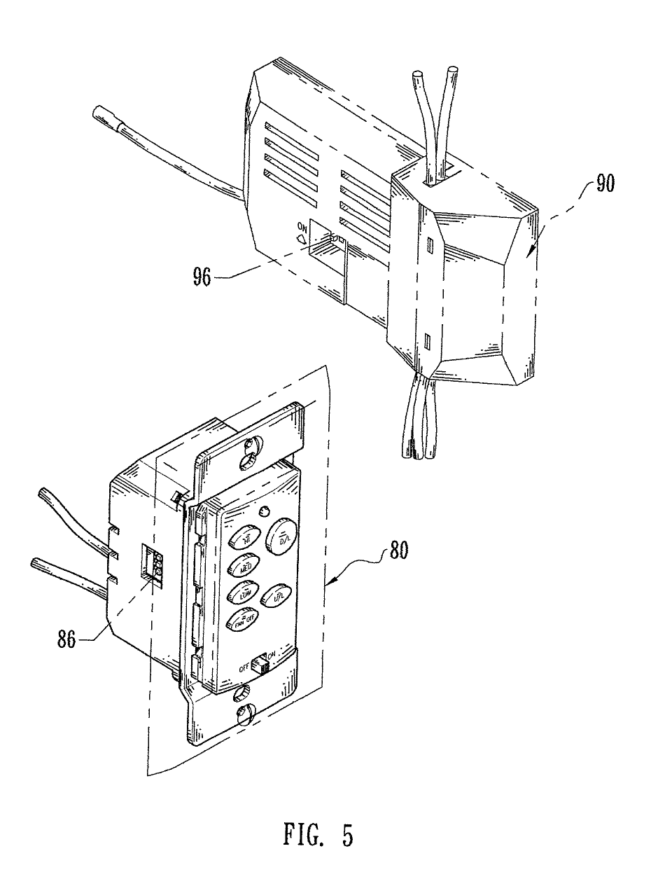

### DETAILED DESCRIPTION OF THE INVENTION

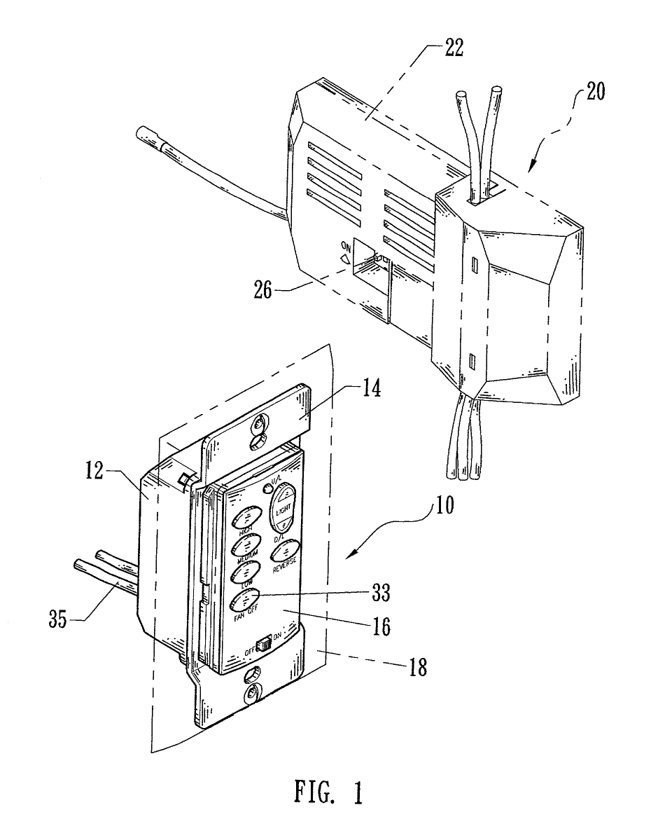

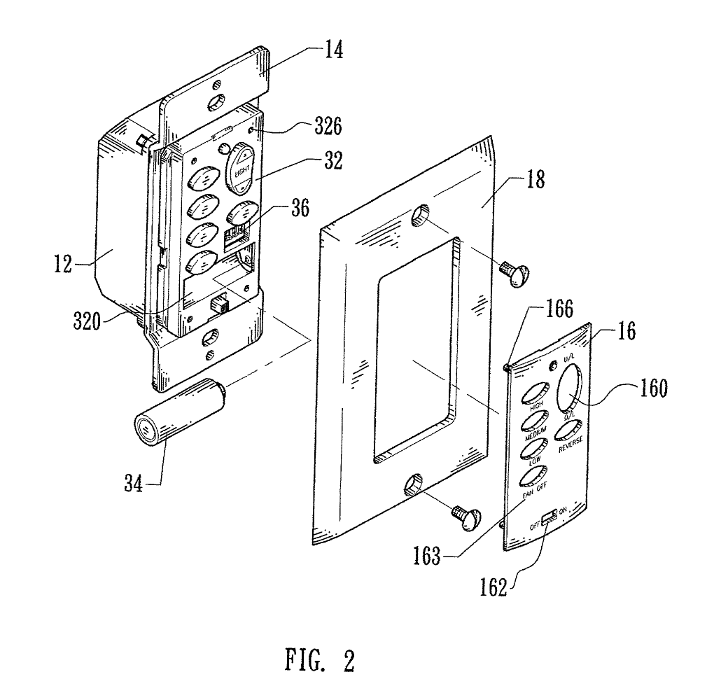

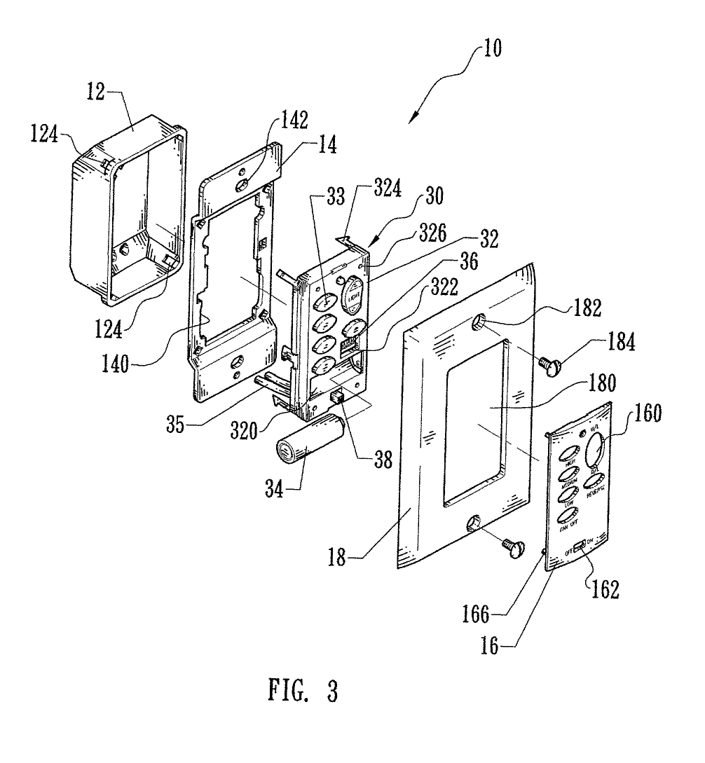

Referring to the drawings and initially to FIGS. 1-3, a wall hanging type switch device of a ceiling fan in accordance with a first embodiment of the present invention comprises a control switch 10 mounted on a vertical wall (not shown), and a receiver 20 mounted in a ceiling fan (not shown) and controlled by the control switch 10 in a wireless manner.

The receiver 20 includes a body 22, and an encoder 26 mounted in the body 22.

The control switch 10 includes a casing 12 secured in the vertical wall, a support frame 14 mounted on the casing 12, an emitter 30 mounted on the support frame 14, a slotted cover 18 mounted on the support frame 14 to enclose the support frame 14 and the emitter 30, and a face plate 16 removably mounted on the emitter 30.

The casing 12 has four corners each formed with a locking hole 124.

The support frame 14 is formed with an opening 140 for receiving the emitter 30, and has two opposite sides each formed with a through hole 142.

The emitter 30 may be used to control the receiver 20, and includes a body 32, multiple press buttons 33, a battery 34, two electric cords 35, an encoder 36, and a power switch 38.

The body 32 is mounted in the opening 140 of the support frame 14, and is provided with four hooks 324 each extended through the opening 140 of the support frame 14 and each locked in the locking hole 124 of the casing 12. The body 32 has four corners each formed with a socket 326. The multiple press buttons 33 are mounted on the body 32 for controlling operation of the ceiling fan, such as the rotation velocity of the ceiling fan, the direction (positive or reverse) of rotation of the ceiling fan, or the like. The battery 34 is mounted in a receiving chamber 320 formed in the body 32 for supplying an electric power to the emitter 30, so that the emitter 30 may supply a wireless signal to the receiver 20. The two electric cords 35 are connected to the ceiling fan for connecting or disconnecting the power supply of the ceiling fan. The encoder 36 is mounted in a space 322 formed in the body 32, and has codes in correspondence with that contained in the encoder 26 of the receiver 20. The power switch 38 is mounted on the body 32 and is connected with the two electric cords 35 for turning on or turning off the ceiling fan.

The face plate 16 is removably mounted on the body 32 of the emitter 30, and has four corners each provided with a plug 166 inserted into the socket 326 of the body 32 of the emitter 30 for detachably mounting the face plate 16 on the body 32 of the emitter 30. The face plate 16 is formed with multiple oblong slots 160 for receiving the multiple press buttons 33 of the emitter 30, and formed with a rectangular slot 162 for receiving the power switch 38 of the emitter 30. The face plate 16 may be provided with multiple indicators 163 adjacent to the slots 160 and 162 for indicating the states of operation of the ceiling fan, such as the rotation velocity of the ceiling fan, the direction (positive or reverse) of rotation of the ceiling fan, or the like.

The cover 18 is formed with an opening 180 for exposing the face plate 16, and has two opposite sides each formed with a through hole 182. Two locking screws 184 are each extended through the though hole 182 of the cover 18, the through hole 142 of the support frame 14, and are each screwed into the vertical wall, for securing the support frame 14 and the cover 18 on the vertical wall.

In operation, the battery 34 may supply the electric power to the emitter 30, so that when one of the press buttons 33 is pressed, the emitter 30 may send a wireless electric signal to the receiver 20 so as to control operation of the ceiling fan, such as the rotation velocity of the ceiling fan, the direction (positive or reverse) of rotation of the ceiling fan, or the like. In addition, the two electric cords 35 are connected between the ceiling fan and the power switch 38 for connecting or disconnecting the power supply of the ceiling fan, so that the power switch 38 may be switched for turning on or turning off the ceiling fan.

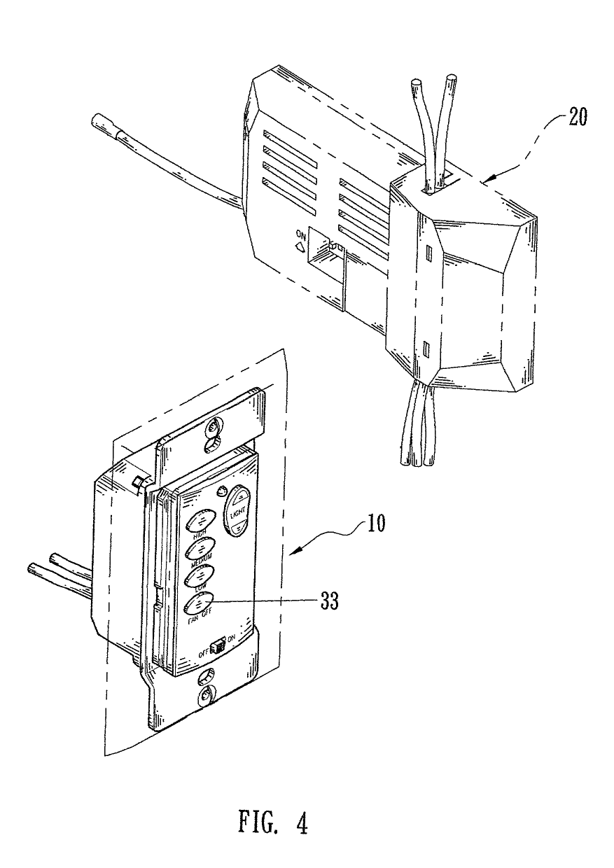

Referring to FIG. 4, the wall hanging type switch device of a ceiling fan in accordance with a second embodiment of the present invention has different numbers of press buttons 33.

Accordingly, the wall hanging type switch device of a ceiling fan in accordance with the present invention has the following advantages.

1. The face plate 16 may be detached and removed from the body 32 of the emitter 30 easily and rapidly, thereby facilitating replacing the battery 34.

2. The face plate 16 may be detached and removed from the body 32 of the emitter 30 easily and rapidly, thereby facilitating the user adjusting the codes of the encoder 36 to correspond to the codes of the encoder 26 of the receiver 20.

3. The electric power of the emitter 30 is supplied by the battery 34 that has a direct current voltage of 12V, so that the emitter 30 needs not to be additionally provided other parts such as the transformer and the like, so that the emitter 30 may be made with a relatively smaller volume, thereby greatly shortening the volume of the emitter 30, and thereby greatly shortening the volume of the wall hanging type switch device of the present invention.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A wall hanging type switch device of a ceiling fan, comprising:
a receiver; and
a control switch, including an emitter for controlling the receiver in a wireless manner, and a face plate removably mounted on the emitter.

2. The wall hanging type switch device of a ceiling fan in accordance with claim 1, wherein the control switch further includes:
a casing;
a support frame mounted on the casing, and the emitter mounted on the support frame; and
a slotted cover mounted on the support frame to enclose the support frame and the emitter.

3. The wall hanging type switch device of a ceiling fan in accordance with claim 2, wherein the emitter includes a body mounted on the support frame and secured to the casing.

4. The wall hanging type switch device of a ceiling fan in accordance with claim 3, wherein the casing has four corners each formed with a locking hole, and the body of the emitter is provided with four hooks each locked in the locking hole of the casing.

5. The wall hanging type switch device of a ceiling fan in accordance with claim 3, wherein the body of the emitter has four corners each formed with a socket, and the face plate has four corners each provided with a plug inserted into the socket of the body of the emitter for detachably mounting the face plate on the body of the emitter.

6. The wall hanging type switch device of a ceiling fan in accordance with claim 3, wherein the emitter includes a battery mounted in a receiving chamber formed in the body for supplying an electric power to the emitter, so that the emitter may supply a wireless signal to the receiver.

7. The wall hanging type switch device of a ceiling fan in accordance with claim 3, wherein the emitter includes an encoder mounted in a space formed in the body.

8. The wall hanging type switch device of a ceiling fan in accordance with claim 2, wherein the support frame is formed with an opening for receiving the emitter.
